(19) United States
(12) Patent Application Publication
(10) Pub. No.: US 2005/0066292 A1
(43) Pub. Date: Mar. 24, 2005

(54) Virtual piles desktop interface

(75) Inventor: Steven J. Harrington, Webster, NY (US)

Correspondence Address: Patent Documentation Center;Xerox Corporation, Xerox Square 20th Floor, 100 Clinton Avenue S., Rochester, NY, 14644, US

(73) Assignee: Xerox Corporation

(21) Appl. No.: 10/669,904

(22) Filed: Sep. 24, 2003

(51) Int. Cl. G06F 3/00

(52) U.S. Cl. 715/835; 715/853; 715/788

(57) ABSTRACT

What is disclosed is a user interface metaphor for grouping and organizing documents on a desktop while they are still in use or until a final organizational structure is chosen. The present invention allows them to be grouped and organized, yet remain individually accessible within the limited screen real-estate that is typically available. Therein, documents are collected in virtual piles that are built by dragging and dropping document icons on top of each other to form a pile. Icons not on the top of the pile are represented by line segments of varying widths, lengths, and colors indicating document size, type, priority, etc. The method replaces the typical icons with lines of varying dimensions, colors and patterns that can be stacked together into a compact virtual pile. If the mouse is rolled over the line segment representing one of the documents, the full name of the document would be displayed.

### FIELD OF THE INVENTION

The present invention generally relates to methods for handling and managing desktop icons and, more particularly, methods for enabling icons to be grouped together or otherwise collected together.

### BACKGROUND OF THE INVENTION

In the world of hard-copy documents, one can often find a messy desk containing stacks or piles on paper. This effect may actually be providing a way to loosely organize documents while they are still in use, or until a final organizational structure is understood. It is convenient to move documents out of the immediate workspace, yet to have them quickly available. It is also convenient to group the documents together as an aid in thinking about how documents are related and as an aid in locating and retrieving a document. Current workstation desktops for electronic documents do not support this loose organizational model. Fully open documents are far too large to show more that one or two at a time. Small icons are better but still consume a fair amount of screen space so that the compactness of the groups is limited. This means that only a few group or a few documents per group can be supported. It also means that the icons are likely to be covered by open documents and therefore less accessible.

What is needed in this art is a method for organizing desktop documents while such documents are still in use.

### BRIEF SUMMARY OF THE INVENTION

What is disclosed is a user interface metaphor for grouping and organizing documents on a desktop while they are still in use or until a final organizational structure is chosen. The present invention allows them to be grouped and organized, yet remain individually accessible within the limited screen real-estate that is typically available. Therein, documents are collected in virtual piles that are built by dragging and dropping document icons on top of each other to form a pile. Icons not on the top of the pile are represented by line segments of varying widths, lengths, and colors indicating document size, type, priority, etc. The method replaces the typical icons with lines of varying dimensions, colors and patterns that can be stacked together into a compact virtual pile. If the mouse is rolled over the line segment representing one of the documents, the full name of the document would be displayed.

### BRIEF DESCRIPTION OF THE DRAWINGS

FIG. 1 illustrates 3 separate documents on the left and an exemplary iconic representation of a virtual pile of these documents.

FIG. 2 illustrates a text box being presented to the user upon a mouse-over event having occurred.

FIG. 3 illustrates an alternative embodiment of information being displayed to the user upon a mouse-over event having occurred.

### DESCRIPTION OF THE SPECIFICATION

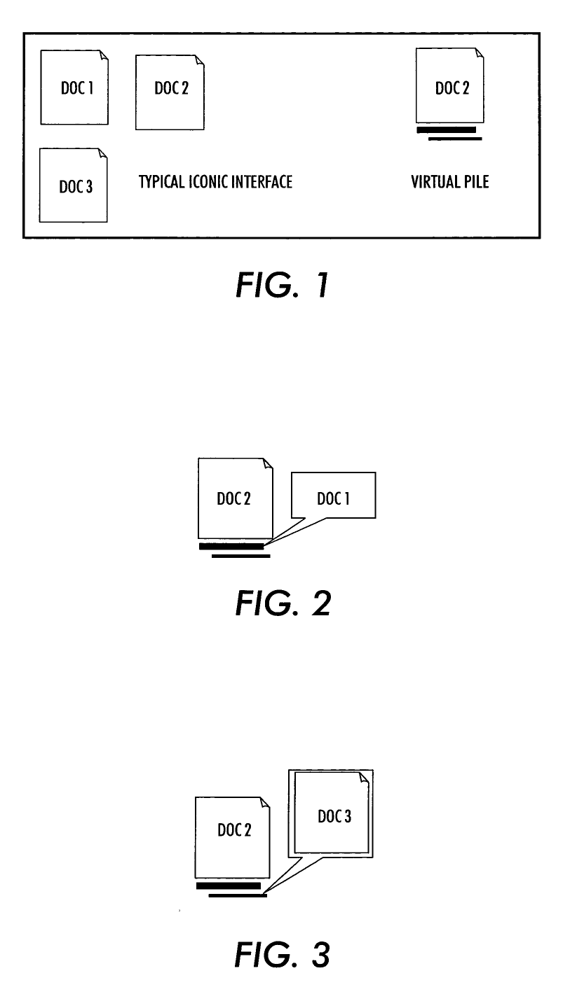

The present invention solves the above identified problem in this art by allowing icons to be grouped into what is referred herein as “virtual piles.” When an icon is dragged over the top of another icon and released, a pile of icons is formed. If a icon is dragged onto a virtual pile of icons the pile grows. Only the top icon in the pile will be presented or otherwise displayed on the user's display in its normal and customary form. All the other icons which have been dropped onto the pile are displayed or otherwise represented in a separate form which illustrates the concept of being piled or compacted. One exemplary separate form for an icon representative of a pile of icons is shown in FIG. 1 as a line segment. In FIG. 1, the documents comprising the pile are illustrated on the left. These are shown as Doc1, Doc2 and Doc3 and as having the typical iconic representation of a word or text document. Doc1 and Doc3 have been dragged and dropped on top of Doc2 to form a pile. When these two documents have been piled onto Doc2, then the customary iconic representation of Doc2 is modified to illustrate or otherwise indicate to the user that a pile of documents exist thereunder. Other representative forms such as: an actual pile, a clump, a cluster, and the like are anticipated herein and are to be considered within the scope of the present invention.

In the example of FIG. 1, the line underneath the icon of Doc2 which indicates a virtual pile in accordance herewith can additionally be varied in one or more dimensions to indicate the amount of documents comprising the pile or the degree to which the pile is stacked. For instance, the line underneath the iconic representation of Doc2 indicating a pile thereof could be increased in width (made fatter or thicker) as more and more other documents are piled on top. Alternatively, the line could be made longer in length (or shorter) wherein the overall length (or lack thereof) indicates to the user the amount of documents in the pile. Alternatively, a small digit or other alphanumeric characters could be appended or pre-pended thereto in order to provide this same indication. Or, a plurality of line segments would also serve to indicate a virtual pile.

The line segments used in a pile can vary to distinguish and identify the pile elements. Length, thickness, alignment, color and pattern also differentiate elements. As an aid in matching the line segments to the documents, rules are anticipated being used to generated various appearances. For example, line thickness could be keyed to document length and patterns could be used to identify the document type.

Documents belonging to a virtual pile can be identified by responding to the identification of a pile element such as by means of a “mouse-over” by displaying a balloon box providing the user thereof with document identification information. One example in this regard is shown in FIG. 2 wherein a text box is displayed upon a mouse-over event having occurred. The mouse-over is preferably initiated by the mouse passing over the X-Y coordinates encompassing the iconic representation, as used in accordance herewith, to indicate a pile.

Alternatively, as is illustrated in FIG. 3, the mouse-over event could also activate textual or iconic representations to arise. Furthermore, sound or other images or sequences of images are envisioned herein and are thus to be considered encompassed within the scope of the present invention.

Selecting and dragging individual elements from the virtual pile reduces the size of the pile. Similarly, removing all the members which were piled on top of each other restores the iconic representation of the last member at the bottom of the pile to its original iconic form.

One skilled in the art of programming for desktop software wherein icons are routinely displayed would readily be able to code the present invention to their specific operating system in accordance with this disclosure. As programming languages vary widely from operating system to operating system (and across uses as well) any pseudo-code representative of an implementation of the present invention would more likely confuse than otherwise illustrate. As such, any coding of the present invention has been purposefully omitted.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for clustering icons into a virtual pile, comprising:
a) identifying a first icon to represent the said virtual pile;
b) selecting another icon to be placed onto said virtual pile;
c) indicating that said selected icon is to be added to said virtual pile;
d) modifying said first icon at least once to indicate a pile thereunder; and
e) repeating (b-d) until done.

2. A method as in claim 1, further comprising subsequent icons disappearing at least in part from view upon placement on said pile.

3. A method as in claim 1, further comprising subsequent icons changing in appearance to represent being part of said virtual pile upon placement on said pile.

4. A method as in claim 1, upon release of subsequent icons onto said pile, further indicating that another icon was successfully added thereto.

5. A method as in claim 4, wherein said further indication that another icon was successfully added thereto, playing at least one sound.

6. A method as in claim 4, wherein said further indication that another icon was successfully added thereto, displaying at least one graphic.

7. A method as in claim 1, upon identification of said first icon, selecting said first icon as a start of the virtual pile.

8. A method as in claim 7, upon selection of said first icon as the start of the virtual pile, further modifying said first icon so as to indicate that it now represents a virtual pile.

9. A method as in claim 8, wherein said further modifying of said first icon is such that it indicates that it now represents a single element pile.

10. A method as in claim 1, the modification of said first icon further comprising providing a number representative of the total elements piled thereunder.

11. A method as in claim 1, the modification of said first icon further comprising tagging said first icon with miniature renditions of at least one of the elements piled thereunder.

12. A method as in claim 1, the modification of said first icon further comprising providing a number representative of the total elements piled thereunder.

13. A method as in claim 1, the modification of said first icon further comprising providing information as to the type of elements piled thereunder.

14. A method as in claim 1, wherein modification of said first icon further comprises changing said first icon's label.

15. A method as in claim 14, wherein changing of said first icon's label comprises adding at least one character thereto or subtracting at least one character therefrom.

16. A method as in claim 1, wherein modification of said first icon further comprises associating a graphic therewith for at least one element piled thereunder.

17. A method as in claim 16, wherein said associated graphics vary as to distinguish elements piled thereunder.

18. A method as in claim 17, wherein said associated graphics comprise line segments which vary in at least one of length, thickness, alignment, color, or pattern.

19. A method as in claim 18, further displaying balloon boxes providing additional information as to the elements in the pile.

20. A method as in claim 19, further identifying documents thereunder.

21. A method as in claim 1, on a mouse passing over or being placed on or in proximity to said pile, further initiating a mouse-over event.

22. A method as in claim 21, on said mouse-over event, further providing information regarding the virtual pile.

23. A method as in claim 21, on said mouse-over event, further providing information regarding at least one element in the pile.

24. A method as in claim 21, on said mouse-over event, further opening at least one element in the pile.

25. A method as in claim 21, on said mouse-over event further initiating at least one of: text, sound, images, sequences, or display

26. A method as in claim 1, wherein said indicating that a selected icon is to be added comprises
a) dragging said selected icon into close proximity of said virtual pile; and
b) releasing said selected icon onto said virtual pile.

27. A method for enabling the removal of icons from a virtual pile comprising:
a) identifying a virtual pile;
b) selecting at least one element in said pile;
c) providing an icon for said selected element;
d) modifying said virtual pile to indicate the removal of the element.

28. A method as in claim 27, wherein said providing an icon for said selected element comprises restoring the original iconic representation thereof.

29. A method as in claim 27, wherein said providing an icon for said selected element comprises creating a new iconic representation therefor.

30. A method as in claim 27, wherein the removal of elements from said pile is done by a drag-and-drop action.

31. A method as in claim 27, upon removal of all elements previously added to the pile, further restoring the original representation of said first icon.

32. A method as in claim 27, wherein the removal of elements from said pile is done responsive to a mouse-over event.

33. A method as in claim 32, on said mouse-over event further providing an exploded view of all elements in the pile.

34. A method as in claim 32, on said mouse-over event removing all elements from the pile.

35. A method as in claim 34, upon removal of elements from the pile, further restoring at least one removed element's original iconic representation.

36. A method as in claim 32, upon removal of elements from the pile, creating a new iconic representation for at least one removed element.

37. A method as in claim 27, said removal being responsive to a computer system initiated event.

38. A method as in claim 27 said removal being responsive to a network initiated event.

39. The method as in claim 27, wherein the modifying of said virtual pile includes the modification of its icon.

40. The method as in claim 27, wherein the selecting of said virtual pile is done by selection of its icon with a pointing device.

41. The method as in claim 27, wherein the selecting of an element contained within said virtual pile is done by selecting the element indicated by a mouse-over event.

42. The method as in claim 27, wherein the icon created for said selected element matches the icon the element had prior to being added to the virtual pile.

43. The method as in claim 27, wherein the modification of the virtual pile includes no longer indicating the element as a member of the pile.

44. A method as in claim 27, said removal initiating a network event.

45. A method as in claim 27, said removal initiating an email event.

46. A method as in claim 27, said removal initiating a computer event.
